(19) United States
(12) Patent Application Publication
(10) Pub. No.: US 2004/0028195 A1
(43) Pub. Date: Feb. 12, 2004

(54) Internet wired audio device

(76) Inventors: Andrew P Leyden, Chesapeak, MD (US); Kenneth A Fesler, Sunnyvale, CA (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/203,933

(22) PCT Filed: Feb. 16, 2001
(86) PCT No.: PCT/US01/04966

(51) Int. Cl. G10L 11/00; G10L 21/00; H04M 1/64

(52) U.S. Cl. 379/88.17; 704/275

(57) ABSTRACT

A digital audio system and method for accessing digital audio broadcasts and files over a computer network. The digital audio device of the present invention provides an apparatus for connecting to and receiving digital audio broadcasts and files without the need for a personal computer. A method is provided for simplifying access to the broadcast and file addresses. Each address is assigned a channel number for entering into the digital audio device in lieu of its URL. With the system and method of the present invention the digital audio device provides features much like a standard radio, but when connected to the Internet it is capable of accessing any radio station in the world that broadcasts over the Internet. The digital audio device can also provide features similar to that of a jukebox, in that individual songs or programs can be purchased for single or multiple uses.

### CROSS-REFERENCE TO RELATED APPLICATION

This application claims the benefit of U.S. Provisional Patent Application No. 60/183,604, filed Feb. 18, 2000, and entitled “Internet Wired Audio Device.”

### BACKGROUND OF THE INVENTION

1. Field of the Invention

This invention relates to a system and method for receiving digital audio broadcasts and files transmitted over the Internet. More specifically, this invention relates to a stand-alone non-PC-based Internet audio appliance.

2. Discussion of the Related Art

In the United States, here are roughly 536 million radios, nearly five radios Der household. However, each of these radios has major limitations. The radio's antenna size and geographic location limit the number of radio stations each can receive. Even though there are approximately 12,000 radio stations in the United States, only about 50 stations can be heard in any given major metropolitan area. In rural areas, this number is only about 20. However, at this time, over 5,000 radio stations also are making their broadcasts available via the Internet.

Although audio broadcasts currently are being transmitted over the Internet via technology called streaming audio, a major disadvantage or limitation is that a listener must have a rather advanced computer, with sufficient communications bandwidth, in order to listen to traditional radio via the Internet. In nearly every case, the listener must be “tethered to their computer” by a device requiring direct connection to the user's computer. Users also have extremely limited options for locating and receiving the Internet radio stations they desire.

It is therefore an object of the present invention to provide a system and method for retrieving and utilizing Internet audio broadcasts without the significant expense of a personal computer.

It is a further object of the present invention to provide a digital appliance capable of playing digital audio broadcast files and digital audio files.

It is a further object of the present invention to provide a method for accessing digital audio broadcast files and digital audio files with a simplified numbering system.

### SUMMARY OF THE INVENTION

The present invention relates to a system and method for retrieving and using audio broadcasts transmitted via the Internet. More specifically, the present invention provides the ability to use a stand-alone non-PC-based Internet audio device to receive a streaming audio feed or audio file transfer from the Internet.

In accordance with the present invention, this design provides several advantages over current Internet radio methods. The Internet audio device of the present invention is simple to use. The Internet audio device expands radio's potential, extending its reach to far corners of the globe via the Internet without requiring the use of a PC. It has fully searchable directories that can be accessed using a standard telephone-like keypad and a simple visual display.

In accordance with the present invention, the Internet audio device's simple and easy to use directories allow users to find the stations or songs they desire in a quick and efficient manner without requiring knowledge of the Internet. Using the present invention's channel numbering system, complicated Internet URL addresses for the various radio broadcast and audio files are each assigned a unique number. Once a number has been assigned to a specific broadcast or audio file it does not change, even if its corresponding URL changes to retrieve a radio broadcast or audio file using the Internet audio device of the present invention, one simply has to enter a number. The servers of the present invention are configured to provide the proper URLs of Internet audio files to the audio device with the assistance of the channel numbering system and method. There is no need to enter a complex URL into the Internet audio device.

In accordance with another feature of the present invention, and using the same framework for delivering audio broadcasts transmitted via the Internet, the Internet audio device revolutionizes the delivery of music by functioning as an Internet “jukebox.” Utilizing The Internet audio device's number system, users choose from a database of thousands of recordings, purchase rights to listen to a song, and have the music delivered in streaming audio format or via file transfer, on demand. This Internet jukebox eliminates the necessity of a user to physically possess a recording, such as a CD or cassette tape, to play the music.

### BRIEF DESCRIPTION OF THE ATTACHED DRAWINGS

The accompanying drawings, which are included to provide a further understanding of the invention and are incorporated in and constitute a part of this specification, Illustrate embodiments of the invention and together with the description serve to explain the principles of the invention. In the drawings:

FIG. 1 is a block diagram of the Internet audio device in accordance with embodiments of the present invention;

FIG. 2 is a block diagram of the Internet audio device, including optional elements, in accordance with the preferred embodiment of the present invention; and

FIG. 3 is a flow diagram of the audio file access method using a channel numbering system and database in accordance with an embodiment of the present invention.

### DETAILED DESCRIPTION OF THE PREFERRED EMBODIMENT

The present invention is a next generation Internet audio system and appliance. The following embodiment is merely illustrative of one implementation of the present invention, and it is not intended to be limited to this particular example. The features of the herein-described appliance could be adapted to any Internet enabled device, including, but not limited to, mobile phones, personal digital assistants, any Internet enabled radio, and personal computers. The Internet audio appliance provides the ability to play radio broadcasts or audio files that are available over the Internet in a simple and cost-efficient manner.

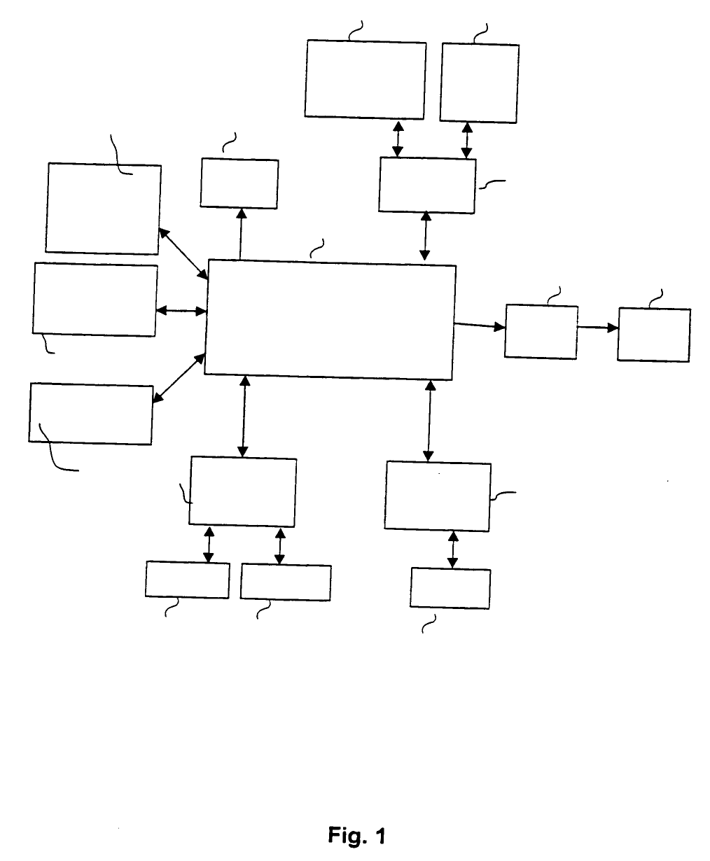

Referring to FIG. 1, the appliance of the present invention in one preferred embodiment is a simple, stand-alone box-like device. Externally, it looks like any other home audio or video component and is designed to connect to an audio system. The preferred embodiment of the appliance device includes a processor 10; a display device 12; a flash memory device 14; a random access memory device 16; a disk drive 18; a network interface 20, including dial-up 21 and Ethernet 29 capabilities; a peripheral interface 30 with USB 39 functionality; a sound processing chip 40 and audio output port 41; and a user interface 50 with a multi-key key pad having alphanumeric keys 55, and infrared or RF remote control 51 capabilities. Additional user interface functionality includes a volume control; an on/off switch; play control features, including hardwired, as well as soft presets (preferably including compact disc player-like controls including play, pause, skip forward, skip backward, search forward, and search backward controls); and a database interface that provides browsing of the entire database, browsing nested menus by genre or geographic regions, entering a channel number and various searching capabilities.

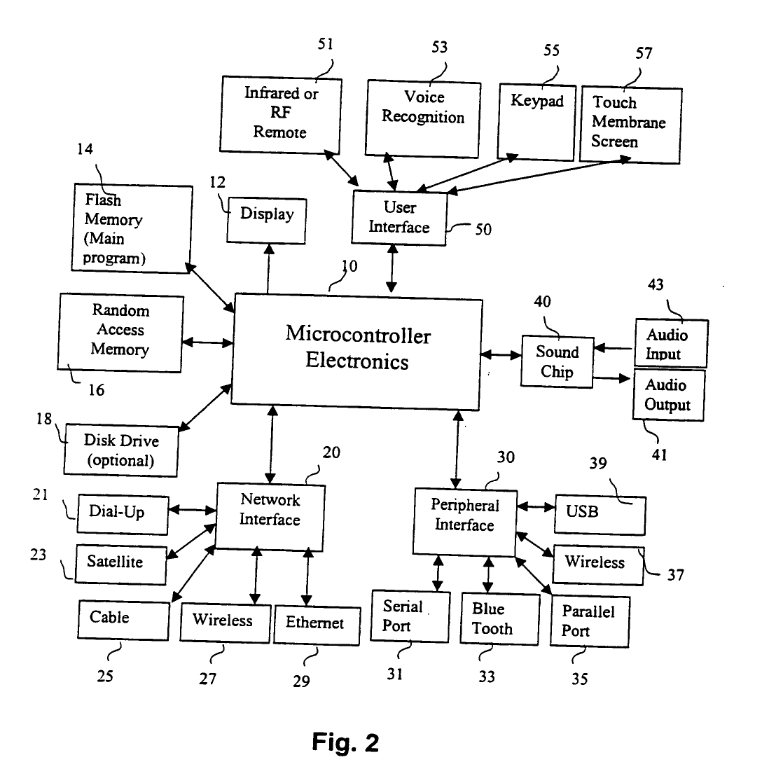

Referring to FIG. 2, additional embodiments of the present invention may provide various options. Additional embodiments of the network interface 20 may also provide cable modem 25, satellite system 23 or other broadband communication, or even wireless capabilities 27. The peripheral interface 30 of additional embodiments may also include a serial port 31, a blue tooth port 33, a parallel port 35, or a wireless port 37. Additional embodiments of the sound processing circuitry 40 may also include an audio input port 43. As well, the user interface 50 of additional embodiments of the present invention may include a voice recognition interface 53, or a touch screen interface 57.

The processor of the preferred embodiment of the present invention is a typical computer processor. The processor, together with a sound chip, is capable of processing streaming and other digital audio files. The memory device 16 is preferably configured with at least 8 MB of random access memory. The storage device 14 is preferably comprised of at least 8 MB of flash memory device or a hard disk and is used to store the operating system, network connectivity programs, audio codec software, and various other system software. The optional disk drive 18 may also be used for storing system software, or additionally, MP3 format or other similar files that can be downloaded securely through the Internet or a private network. The audio output 41 may include a headphone jack, speaker jacks and/or RCA jacks. Additionally, the display, which can be located on either the device or the remote control unit, or both, may be LCD or LED type displays.

The application device is pre-configured with several software programs that enable it to serve as an Internet enabled device. In preferred embodiments, the device is written to run on the LINUX open source operating system. The software programs include Internet connectivity software that allows dial-up, DSL, cable or other means of connection to the Internet, as well as software for decoding audio content provided over the Internet in a variety of formats.

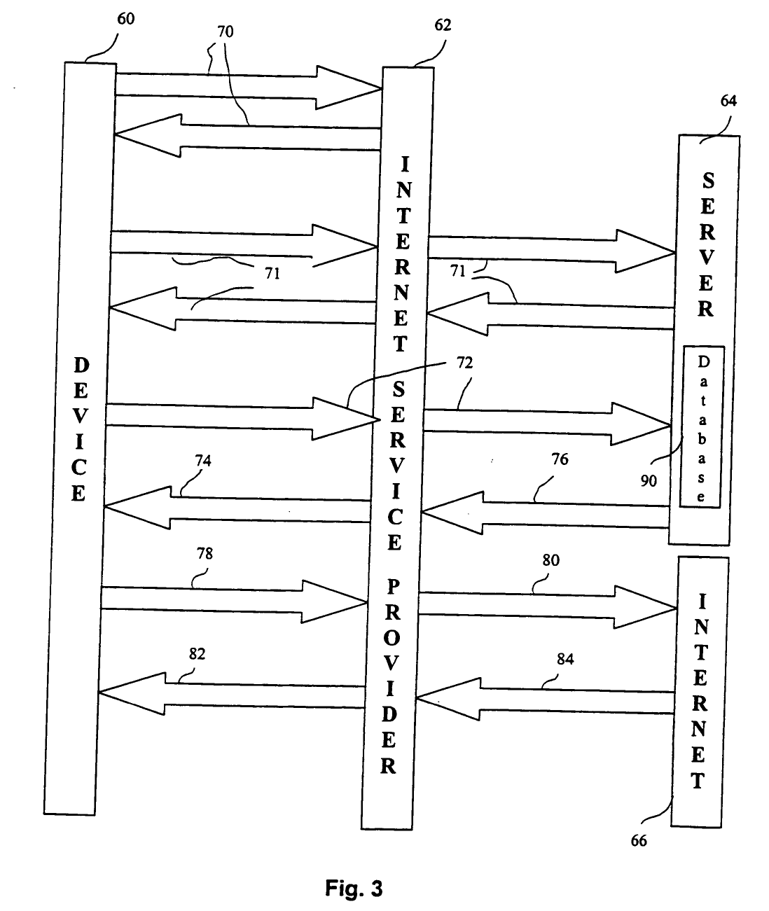

Referring to FIG. 3, a preferred embodiment of the system and method for accessing radio broadcasts and audio files over the Internet is displayed. The radio system comprises a device 60, an Internet service provider 62 with access to the Internet 66, an audio content lookup server 64 that is accessible via the Internet service provider 62, and a database 90 located on the audio content lookup server 64.

The device 60 software operates according to a numbering system-based channel selection feature, referred to in the preferred embodiment as the WEI (What, Everything, Internet) numbering system. Using the WEI numbering system a user is able to request a radio broadcast or an individual audio file without entering a URL or other filename request. The user can retrieve an audio broadcast or individual audio file by simply entering, through the user interface, a uniquely assigned number corresponding to the radio station or other Internet audio source URL. The device then sends the numbered request to the server 64 where a database 90 containing file source information, including the unique WEI number, translates the request into a URL.

Specifically, the connectivity is as follows: 1) to begin a request session, the device establishes a connection with an ISP via conventional Internet protocols, step 70; 2) the device then transmits to the server user authentication, that upon the responding transmission from the server establishes user information (such as soft presets and user preferences), step 71; 3) a WEI number request is then sent from the WEI numbering system database on the device, step 72; this request is converted into a URL address of an existing audio link or other Internet audio source; 4) the URL address is sent to the ISP, step 76; 5) the URL address is then transmitted to the device, step 74; 6) the device sends the URL address to the ISP, step 78; 7) the ISP then routes the URL request to the network, finding the feed for the desired radio station or other Internet audio source, step 80; 8) the radio station then sends the streaming audio feed to the ISP, step 84; and 9) the ISP sends the streaming audio feed to the device, step 82. If the radio station is unavailable, an error message is returned. To listen to another radio station or other Internet audio source, a new WEI number is entered which will start a new request session.

The preferred embodiment of the WEI numbering system database comprises a set of records containing the following fields:

| | |
|---|---|
| WEI id number | 1-7 digit, unique id. |
| Station Name | The common name of the radio station/audio |
| | feed. |
| Call Sign | The station/source name without frequency |
| | numbers. |
| URL | Uniform Resource Locator for the audio feed. |
| City | The city associated with the radio station or |
| | audio feed. |
| State | The state (or Canadian province) associated |
| | with the radio station or audio feed, if |
| | applicable. |
| Country | The country associated with the radio station |
| | or audio feed |
| Format | Audio feed format, e.g. News, Talk, Top 40, |
| | etc . . . |
| Notes | Description of the audio feed. |
| Feed | Feed type, e.g., Live, On Demand, Time |
| | Specific. |
| Speed | Audio stream speed. |
| Web site | Audio feed's origination web site. |
| Preference | Field for organizing list of stations. |

Additional embodiments of the present invention may provide voice recognition elements for accessing radio broadcasts and audio files over the Internet, wherein a specific word or phrase, when spoken into an audio input device, results in the delivery of a streaming audio feed associated with such specific word or phrase. In the same manner that the WEI id number is associated with a particular audio feed's address in the database, such a specific word or phrase can be used in a similar manner. Still, however, one of ordinary skill in the art will recognize that the WEI id number and voice commands serve to mask the particular address for an audio source such that the end user does not need to know the current address for a particular source.

The WEI id number is the key to the database of the present invention. It is a one to seven-digit code randomly assigned by the database program to correspond to a particular audio feed. The number, once assigned to a radio station, will never change, even though the URL addresses that lead to many of the streaming media feeds within the database will most likely change over time.

The Station Name is the common name of the radio station. For example, it can include names such as BBC-WorldService, Voice of America-Uzbekistani Service, WHFS-99.1 FM, or Capitol Radio-1530 AM. This field should have the station's name and, if available, the station's frequency (e.g., WHFS-99.1 FM or WTOP-630 AM). The preferred format is Call Sign-Frequency-Band. For a station that has several different feeds the additional feed information can be added. Such as “BBC-Vietnamese service” or “Voice of America-Russian Service.”

The Call Sign, unlike the Station Name, will only include the formal call letters (e.g., WHFS, BBC, or KCBS). For stations with no official call letters the station name or an abridged version of the station name can be used. For example, SpikeRadio would be SpikeRadio in both Station Name and Call Sign. WHFS-99.1 FM would be “WHFS-99.1 FM” in Station Name and “WHFS” in Call Sign. “CheeseHead Rock-106.9 FM” in the Station Name would be just “CheeseHead Rock” in the Call Sign. Frequency numbers are not used in Call Sign.

The URL field contains Internet domain, server and file locations for individual streaming audio feeds or other Internet audio sources. The path contained in URL will generally lead to a file of one of the following types: Real Audio (.ram), Windows Media (.asx), MPEG Level 3 (mp3), or Quicktime (.mov). These streaming audio feeds may be located on the Internet or a private network.

The City field is simply the city name of the location of the radio station. If it involves a service such as the BBC, the source location (i.e. London) is used, not the city or country the station is broadcasting to. For example, BBC-Vietnamese Service would be listed as London, UK, not Hanoi, Vietnam. Additional examples include Deutsche Welle-Berlin, Radio Free Europe-Prague Czech Republic, and Voice of America-Prague.

The State field is used only for states/provinces of the US and Canada.

The Country field is t-e simple name or abbreviation of the country of origin. For example, China would be used instead of The People's Republic of China, and USA would be used instead of The United States of America.

The Format field is used for the description of the station format. Preferably, there are approximately 30 formats used, however one ordinary skill in the art will readily recognize that various numbers of formats can be used to provide various degrees of categorization. If a particular station pro-rides more than one format, such as news and talk, a “/” is used to separate the various formats (i.e. news/talk). Some stations provide a wide variety of formats creating an extremely long entry, such as “sports/soccer/cricket/rugby.” Subdirectories within the Format field are also envisioned as an embodiment of the present invention.

The Notes field contains a description of the audio feed. For example, “Live Vietnamese music from San Jose along with call-in programs.” Limitations such as “Quicktime format” or “Online 12:00 PM to 4:00 PM EST” are also to be included. Any special programming such as “Navy Football” would also be entered in this field. The Notes field ultimately includes the various keywords that will be searched by users looking for particular types of programming.

The Feed field contains one of a few specific descriptions. These descriptions include “Live,” for broadcasts available around the clock; “On Demand,” for archived programs; “Time Specific,” for broadcasts scheduled for specific times, including sporting events.

The Speed field is for the speed of the stream. Although generally not known, entries such as “ISDN” would also be a valid.

The Web Site field lists the Web address of the audio feed or radio station, such as http://www.cnn.com or http://www.cbs.com. This field is not for the Internet address of a third party streaming media provider such as http://www.broadcast.com.

The Preference field is used for organizing the preferences used in listing the stations.

The WEI id number and the URL are the only required fields in each record. This embodiment of the database is simply an example; additional fields in each record are contemplated as additional embodiments of the present invention.

The database provides several unique features. First, the database allows a direct link to the source audio file. Because, according to the present invention, the audio sources are available across hardware platforms, such as mobile phones, personal digital assistants and Internet-enabled car radios, the user is allowed to access the audio source without having to access any other Web page or data.

Also, the WEI number (and, in alternative embodiments, the voice command) masks the audio source's URL. Audio URLs are long and nearly impossible to remember, and they tend to change frequently. However, a user can typically remember a number of seven digits or less, and once assigned, the WEI number will not change.

Additionally, the database, and its related systems and services are all designed specifically for use by next-generation Internet devices. Devices such as mobile phones and personal digital assistants have limited input and interface capabilities. By linking directly to and providing a permanent designation for each audio source in the database, a system has been created that accommodates the limitations associated with these devices.

By using the WEI numbering system, devices according to the present invention can be used as a radio or a jukebox. A user simply enters a WEI number corresponding to a particular radio broadcast or a specific audio file for which listening rights have been secured or may be secured. The device then connects to the audio content lookup server via an ISP to determine from where on the Internet the content can be found. in addition to accessing files by entering a WEI number, a look-up system is also available via the database interface providing users of the present invention the ability to use the following functions:

1) Verifying a URL's or WEI number's presence in the database,

2) Querying the database with a URL to receive its corresponding WEI number,

3) Querying the database with a WEI number to receive its corresponding URL,

4) Querying the database for other information related to its contents (such as querying for jazz audio and receiving a list of jazz music streaming audio feeds), and

5) Verifying whether users querying the database are authorized to do so.

These functions may be initiated by a user or by the underlying program. An instance of the underlying program initiating a function will be when the program plays a streaming audio advertisement before providing the user with their requested streaming audio feed. These functions are initiated to permit users to enter or select a WEI number and then receive streaming audio from the corresponding URL.

Although the device is outwardly designed to look and function like a conventional radio it is basically a task-specific commuter with memory, but having a small display instead of a monitor, and a simple multi-key pad instead of a full-sized keyboard. While its interior components are similar to a PC's, the device operates in a uniquely new way to deliver digital audio to existing home audio systems. In the preferred embodiment the PenguinRadio device attaches to the Internet via a standard high speed modem or an Ethernet card. Additional embodiments may include devices such as a cable modem or other broadband communication device, or a wireless Internet connection. Once connected to the Internet, the device provides the digital audio signal or other data as output to either the audio output, such as a headphone, speaker, RCA jack or a small display. The display is also used to show the WEI number or other messages.

When the device is used for the first time, a configuration screen appears and prompts the user to enter certain information: 1) ISP username, 2) ISP password, 3) local ISP access number or IP address, 4) any special dialing code, and 5) the device's username/password. This information is permanently stored so it will not be necessary to enter this information a second time. Other connection options include utilizing a toll free number to access and receive pre-programmed configuration information. Configuration software upgrades will automaticaly prompt the user via the display when a new version of the software is available. Additionally, of course, users will be able to change and update their original configuration information at any time.

When the device is activated, it sends a request to an Internet server that will receive the request and distribute signals via standard Internet processing. The device buffers the incoming streaming audio, processes the data and outputs the signal. Any text message that is encoded in the file (for example “Software Upgrade Available”) is written to the display.

In accordance with a preferred embodiment of the present invention, a stand-alone non-PC-based Internet audio device expands the capabilities of radio by providing a system and method of selecting an audio channel through a simplified numbering system and receiving a streaming audio feed from the Internet. The proposed system and method will revolutionize the way people listen to music and radio. The present invention creates a far more efficient system for the retrieval and use of audio broadcasts than that already in existence in order to bridge that gap between the streaming audio on the Internet and the mainstream radio and music industries.

While this invention has been described with specific embodiments, many alternatives, modifications and variations will be apparent to those skilled in the art in light of the foregoing description. For example, the device could be a portable unit complete with preinstalled speakers. The device could be a home wireless version that functions as a portable radio. The device could be wireless phone utilizing device's Radio Station/Jukebox look-up system and database. Or the device could be a wireless version that is capable of fitting inside of a car, connection to the Internet via a land-based wireless network or through a satellite Internet provider service, such as Ellipso^{SM}. Accordingly, the present invention as claimed is intended to include all such alternatives, modifications and variations set forth within the spirit and scope of the description.

What is claimed is:

1. A system for providing digital audio broadcasts and digital audio files via a computer network, comprising:
a computer network containing digital audio files and digital audio broadcast files;
an audio appliance connected to the computer network and capable of receiving and playing the digital audio files and digital audio broadcast files; and
a server accessible from the computer network with a database containing addresses to the digital audio files and the digital audio broadcast files, wherein the database also contains a unique identification number for each address;
wherein, said audio appliance is adapted to connect to said server to determine said addresses to the digital audio files and the digital audio broadcast files by transmitting said unique identification number for an address of interest.

2. A digital audio appliance capable of connecting to a computer network and processing digital audio files comprising:
a microprocessor capable of processing digital audio files;
a computer network interface for connecting to a network containing digital audio files, said computer network interface adapted to connect to the computer network to determine an address associated with a desired digital audio file by transmitting said unique identification number for said address associated with said desired digital audio file;
an audio output device for feeding digital or analog audio signals;
a user interface;
a display;
a RAM memory device; and
a data storage device for storing operating system and system software.

3. The digital audio appliance of claim 2, wherein the computer network interface is capable of connecting to the computer network through a dial-up modem, cable modem, digital satellite, wireless network, or an Ethernet connection.

4. The system of claim 2, wherein the audio output device is selected from the group consisting of:
a headphone jack;
a speaker jack; and
RCA jacks.

5. The digital audio appliance of claim 2, wherein the user interface comprises an alpha numeric keypad.

6. The digital audio appliance of claim 2, wherein the user interface comprises an infrared or a radio frequency remote control.

7. The digital audio appliance of claim 6, wherein the remote control further comprises a display device.

8. The digital audio appliance of claim 2, wherein the user interface comprises a voice recognition system.

9. The digital audio appliance of claim 2, further comprising a peripheral interface adaptable to use a serial port, a parallel port, a USB port, a wireless port, or a short range wireless port.

10. A method for accessing and playing digital audio files by using a unique identification number, said method comprising the steps of:
establishing a connection between a digital audio device and a computer network; and
transmitting a unique identification number from the digital audio device to a database connected to the computer network;
converting the unique identification number into a network address for a digital audio source file;
returning the network address to the digital audio device;
requesting file access from the network for the network address;
returning the digital audio file to the digital audio device; and
playing of the digital audio file.

11. The method of claim 10, wherein the transmitting of a unique identification number further comprises requesting a conversion of the unique identification number.

12. The method of claim 10, wherein the converting of the unique identification number further comprises querying the database for a corresponding network address of the digital audio source file.

13. The method of claim 10, further comprising the step of sending an error message when the digital audio source file is unavailable.
